(19) United States
(12) Patent Application Publication
(10) Pub. No.: US 2008/0120394 A1
(43) Pub. Date: May 22, 2008

(54) Network apparatus, data provision location providing method, and recording medium

(76) Inventors: Akira Yokoyama, Kanagawa (JP); Osamu Suzuki, Kanagawa (JP); Mitsuo Nakamura, Kanagawa (JP); Xiaojun Du, Kanagawa (JP); Shinichiro Ozeki, Kanagawa (JP); Yukinari Hirose, Kanagawa (JP); Atsushi Yokoyama, Kanagawa (JP)

Correspondence Address: HARNESS, DICKEY & PIERCE, P.L.C., P.O. BOX 8910, RESTON, VA, 20195, US

(21) Appl. No.: 11/907,568

(22) Filed: Oct. 15, 2007

(30) Foreign Application Priority Data
Oct. 16, 2006 (JP) 2006-281739

(51) Int. Cl. G06F 15/16; G06F 15/173; H04J 1/16

(52) U.S. Cl. 709/217; 370/216; 709/223

(57) ABSTRACT

A network apparatus providing data-related information outside the network apparatus in accordance with a format of structured description, the data-related information being related to data to be provided, is disclosed that includes an external data storage location management part configured to manage the data storage location of the data-related information of an external network apparatus and a data storage location provision part configured to provide, outside the network apparatus, the data storage location of the data-related information of the network apparatus and the data storage location of the data-related information of the external network apparatus.

### BACKGROUND OF THE INVENTION

1. Field of the Invention

The present invention relates generally to network apparatuses, data provision location providing methods, and recording media, and more particularly to a network apparatus that provides information related to data to be provided outside the apparatus in accordance with a format of writing in a structured manner, a data provision location providing method of the network apparatus, and a recording medium storing a program for causing a computer to execute the data provision location providing method of the network apparatus.

2. Description of the Related Art

In these years, RSS (Rich Site Summary) has been used as a method of publishing Web-site update information. RSS is an XML (Extensible Markup Language)-based format that writes metadata such as Web-site headers and summaries in a structured manner.

The update information written in RSS may include the title of each page, address, headers, summary, and update time of a Web site. By using the RSS-written update information, a receiver of the update information can recognize the update information of multiple Web sites with efficiency with a unified method.

Further, some conventional multi-function machines have the function of providing apparatus management information such as communications history in RSS. For example, Japanese Laid-Open Patent Application No. 2006-54732 discloses a case where an RSS reader operating on a computer serving as a client performs centralized management of the apparatus management information of multiple multi-function machines by periodically polling the RSS feeds of the multi-function machines.

The RSS feed refers to a URL that provides an RSS source. The RSS source refers to information according to RSS format.

According to Japanese Laid-Open Patent Application No. 2006-54732, however, it is necessary for a user to enter the RSS feeds of the multi-function machines in the RSS reader. Accordingly, there is a problem in that the user is required to look for the URLs of the RSS feeds provided by each multi-function machine, which is extremely troublesome if there are a large number of multi-function machines.

### SUMMARY OF THE INVENTION

According to one embodiment of the present invention, there are provided a network apparatus in which the above-described problem may be solved or reduced, a data provision location providing method of the network apparatus, and a recording medium storing a program for causing a computer to execute the data provision location providing method of the network apparatus.

According to one embodiment of the present invention, there are provided a network apparatus capable of accurately and easily providing the data storage location of information related to data provided by the network apparatus and other network apparatuses, a data provision location providing method of the network apparatus, and a recording medium storing a program for causing a computer to execute the data provision location providing method of the network apparatus.

According to one embodiment of the present invention, there is provided a network apparatus providing data-related information outside the network apparatus in accordance with a format of structured description, the data-related information being related to data to be provided, the network apparatus including an external data storage location management part configured to manage a data storage location of data-related information of an external network apparatus; and a data storage location provision part configured to provide, outside the network apparatus, a data storage location of the data-related information of the network apparatus and the data storage location of the data-related information of the external network apparatus.

According to one embodiment of the present invention, there is provided a data provision location providing method of a network apparatus providing data-related information outside the network apparatus in accordance with a format of structured description, the data-related information being related to data to be provided, the data provision location providing method including the steps of reading a data storage location of data-related information of an external network apparatus from an external data storage location management part of the network apparatus managing the data storage location; and providing, outside the network apparatus, a data storage location of the data-related information of the network apparatus and the data storage location of the data-related information of the external network apparatus.

According to one embodiment of the present invention, there is provided a computer-readable recording medium on which is recorded a program for causing a computer having a processor, a storage unit, and a communications unit to execute processing according to a data provision location providing method of a network apparatus providing data-related information outside the network apparatus in accordance with a format of structured description, the data-related information being related to data to be provided, the program causing the computer to execute the steps of causing the processor to read a data storage location of data-related information of an external network apparatus from an external data storage location management part of the network apparatus managing the data storage location; and providing, outside the network apparatus, a data storage location of the data-related information of the network apparatus and the data storage location of the data-related information of the external network apparatus, using the communications unit.

According to embodiments of the present invention, it is possible to provide a network apparatus capable of accurately and easily providing the data storage location of information related to data provided by the network apparatus and other network apparatuses, a data provision location providing method of the network apparatus, and a recording medium storing a program for causing a computer to execute the data provision location providing method of the network apparatus.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a system including a network apparatus and a terminal unit according to one embodiment of the present invention;

FIG. 2 is a block diagram showing a software configuration of a multi-function machine according to the embodiment of the present invention;

FIG. 3 is a block diagram showing a configuration of a Web UI according to the embodiment of the present invention;

FIG. 4 is an image diagram showing a Web page that a Web screen provision part provides to a Web browser operated by a user according to the embodiment of the present invention;

FIGS. 5A through 5C are diagrams showing a transition of screens illustrating an operation in the case of entering RSS feeds in an RSS reader using RSS auto-discovery according to the embodiment of the present invention;

FIG. 6 is a diagram illustrating an example of HTML source code in the case of making a description for implementing RSS auto-discovery in a Web page provided by the Web screen provision part according to the embodiment of the present invention;

FIG. 7 is an image diagram showing a Web page that displays a list of RSS feeds provided by the multi-function machine and serves to cause an OPML file into which the RSS feeds are put together to be downloaded according to the embodiment of the present invention;

FIG. 8 is a diagram showing an OPML file provided by an OPML file provision part according to the embodiment of the present invention;

FIG. 9 is a system configuration diagram schematically showing an operation of the multi-function machine according to a first embodiment of the present invention;

FIG. 10 is a flowchart showing the operation of the multi-function machine according to the first embodiment of the present invention;

FIG. 11 is a flowchart showing the operation of the multi-function machine according to the first embodiment of the present invention;

FIG. 12 is a system configuration diagram schematically showing an operation of the multi-function machine according to a second embodiment of the present invention;

FIG. 13 is a flowchart showing the operation of the multi-function machine according to the second embodiment of the present invention;

FIG. 14 is a flowchart showing the operation of the multi-function machine according to the second embodiment of the present invention;

FIG. 15 is a flowchart showing processing on obtained RSS feeds according to the second embodiment of the present invention;

FIG. 16 is a system configuration diagram schematically showing an operation of the multi-function machine according to a third embodiment of the present invention;

FIG. 17 is a flowchart showing the operation of the multi-function machine according to the third embodiment of the present invention;

FIGS. 18A and 18B show example RSS sources obtained from other multi-function machines according to the third embodiment of the present invention;

FIG. 19 shows an OPML source containing RSS feeds provided by the multi-function machine and RSS feeds that are the URLs of RSS sources, obtained from the other multi-function machines according to the third embodiment of the present invention;

FIG. 20 is a system configuration diagram schematically showing an operation of the multi-function machine according to a fourth embodiment of the present invention;

FIG. 21 is a flowchart showing the operation of the multi-function machine according to the fourth embodiment of the present invention;

FIG. 22 shows an RSS source into which RSS sources obtained from other multi-function machines and RSS sources provided by the multi-function machine are merged according to the fourth embodiment of the present invention;

FIG. 23 is a schematic diagram showing a subnet where multi-function machines are provided according to an embodiment of the present invention;

FIG. 24 is a system configuration diagram schematically showing an operation of searching for other multi-function machines on a network according to the embodiment of the present invention;

FIG. 25 is a flowchart showing an example of the operation of searching for other multi-function machines according to the embodiment of the present invention;

FIG. 26 is a flowchart showing an example of the operation of searching for other multi-function machines according to the embodiment of the present invention;

FIG. 27 is a system configuration diagram schematically showing an operation of searching for other multi-function machines on a network according to an embodiment of the present invention; and

FIG. 28 is a flowchart showing an example of the operation of searching for other multi-function machines according to the embodiment of the present invention.

### DETAILED DESCRIPTION OF THE PREFERRED EMBODIMENTS

A description is given below, with reference to the accompanying drawings, of embodiments of the present invention.

In the following embodiments, a description is given of cases where there are multiple multi-function machines capable of providing apparatus management information through RSS feeds and a user enters the URLs of the RSS feeds provided by each multi-function machine in an RSS reader that the user uses. That is, in the following embodiments, a description is given of the technique of making it easy to enter the URLs of the RSS feeds provided by each multi-function machine in the RSS reader. The multi-function machine is an example of the network apparatus.

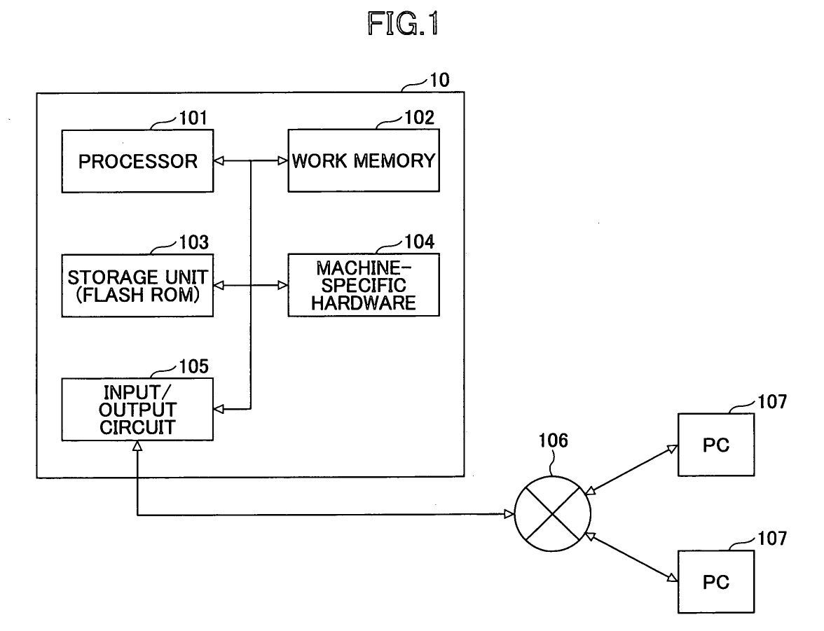

FIG. 1 is a block diagram showing a system including a network apparatus and a terminal unit according to one embodiment of the present invention. Referring to FIG. 1, the system includes a multi-function machine or multi-function peripheral (MFP) 10 and one or more terminal units (PC) 107, which are connected via a predetermined network 106 such as a LAN.

The multi-function machine 10 includes a processor 101, a work memory 102, a storage unit 103 such as a flash ROM, hardware 104 specific to the multi-function machine 10 (hereinafter referred to as “machine-specific hardware 104”), and an input/output circuit 105.

The processor 101 controls the multi-function machine 10. The processor 101, in combination with the machine-specific hardware 104, implements functions specific to the multi-function machine 10. Further, the processor 101 is also used to implement a Web server function in the multi-function machine 10.

The work memory 102 is used as a temporary storage area for executing software or for operations accompanying the software execution. The storage unit 103, which is an electrically rewritable storage medium such as a flash ROM, contains software items such as a control program for implementing the functions of the multi-function machine 10 and a program according to the present invention. The input/output circuit 105 is used to establish connection to the network 106. The machine-specific hardware 104 is hardware specific to the multi-function machine 10.

Referring to FIG. 1, the two terminal units 107 are connected to the multi-function machine 10 via the network 106. The terminal units 107 are operated by users, and transmit various instructions from the users to the multi-function machine 10.

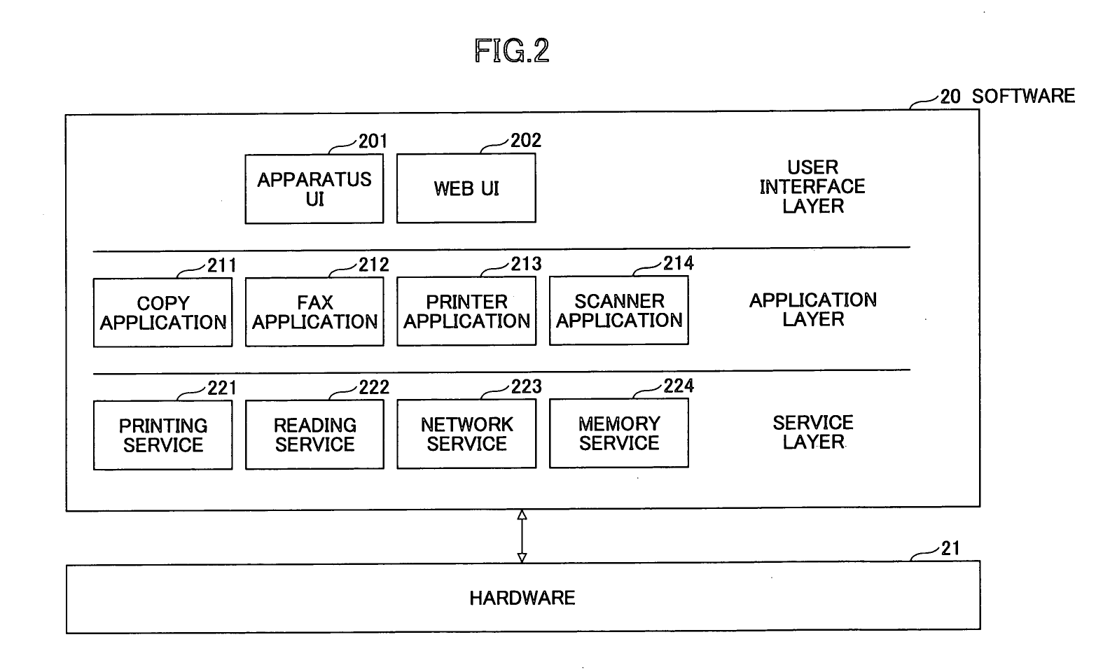

FIG. 2 is a block diagram showing a software configuration of the multi-function machine 10 according to the embodiment of the present invention.

Referring to FIG. 2, the multi-function machine 10 includes software 20 and hardware 21.

The software 20 includes a user interface (UI) layer, an application layer, and a service layer. The user interface layer provides a user with user interfaces. The application layer implements each application function. The service layer controls the hardware 21 and provides applications with their respective functions.

The user interface layer includes an apparatus UI 201 and a Web UI 202. The apparatus UI 201 provides a user interface on the operations panel of the multi-function machine 10. The Web UI 202 provides a user interface for a user of the multi-function machine 10 to operate the multi-function machine 10 from the terminal units 107 using a Web browser.

The application layer includes a copy application 211, a facsimile (FAX) application 212, a printer application 213, and a scanner application 214. The copy application 211 implements a copy function. The FAX application 212 implements a facsimile function. The printer application 213 implements a printer function. The scanner application 214 implements a scanner function.

The service layer includes a printing service 221, a reading service 222, a network service 223, and a memory service 224. The printing service 221 controls a plotter included in the hardware 21. The reading service 222 controls a document reader included in the hardware 21. The network service 223 controls the input/output circuit 105 (FIG. 1). The memory service 224 manages the work memory 102 (FIG. 1).

For example, in the case of a user making a copy of original material such as a document using the operations panel of the multi-function machine 10, first, the apparatus UI 201 receives an instruction from the user. Then, the apparatus UI 201 gives instructions on the contents of a copy operation to the copy application 211. The copy application 211 instructs the reading service 222 and the printing service 221 to read and print the document in accordance with the instructions on the copy operation from the apparatus UI 201. Thus, the user can obtain a copy output result of the document.

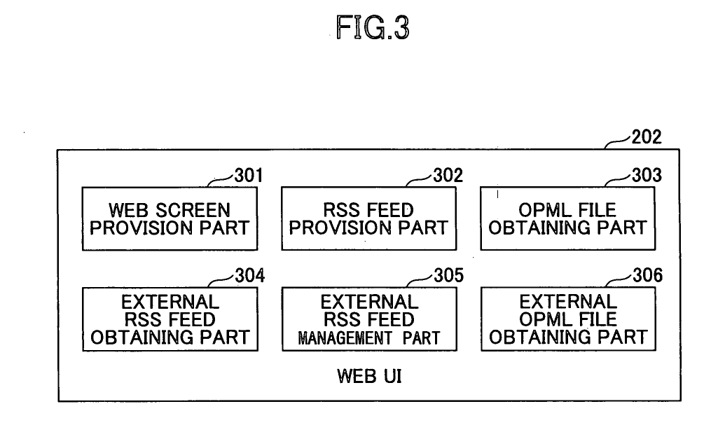

FIG. 3 is a block diagram showing a configuration of the Web UI 202 according to this embodiment. Referring to FIG. 3, the Web UI 202 includes a Web screen provision part 301, an RSS feed provision part 302, an OPML (Outline Processor Markup Language) file provision part 303, an external RSS feed obtaining part 304, an external RSS feed management part 305, and an external OPML file obtaining part 306.

The Web screen provision part 301 receives a request from a Web browser operating on the terminal unit (PC) 107 operated by a user through the network service 233. The Web screen provision part 301 has the function of transmitting a Web page containing apparatus management information to the PC 107 and provides the user with the Web page based on the received request.

Here, the apparatus management information refers to various information items such as apparatus status, energy saving status, error occurrence status, residual toner amount, paper feed tray status, and job history information. These various apparatus management information items may be provided on a single Web page. Usually, however, these information items are often provided on separate Web pages according to their types. For example, the apparatus status, energy saving status, and error occurrence status may be displayed on a Web page that shows general apparatus status as a top page, while a printer job history may be displayed on another Web page displaying job history information.

The RSS feed provision part 302 receives a request from an RSS reader operating on the PC 107 operated by the user through the network service 223. The RSS feed provision part 302 has the function of transmitting an RSS feed containing apparatus management information to the PC 107 and provides the user with the RSS feed based on the received request.

Specifically, the information written (contained) in the RSS feed includes the outline of the apparatus management information and information on the link to a Web page where the details of the apparatus management information can be viewed. The information usually displayed by the RSS reader used by the user is the outline of the apparatus management information. If the user wishes to view the details of the apparatus management information, the user follows the link to the Web page where the details of the apparatus management information displayed by the RSS reader can be viewed, and causes the Web page provided by the Web screen provision part 301 to be displayed using a Web browser or a Web browser function built in the RSS reader, so that the user can view the details of the apparatus management information.

All of the various information items provided as the RSS feed may be provided in a single RSS feed the same as the above-described pages. However, it is difficult for a user to handle an RSS feed containing different types of information. Further, usually, the RSS reader has the function of displaying the contents of multiple RSS feeds in a remixed manner. Accordingly, it is preferable to provide information items as separate RSS feeds according to their types so that the user can use them in a manner as required.

Further, the OPML file provision part 303 has the function of providing, through the network service 223, an OPML file where all the RSS feeds provided by the RSS feed provision part 302 are put together in a list, or as a unit. Here, the URL that provides the OPML file is referred to as an “OPML feed,” and the contents of the OPML file are referred to as an “OPML source.”

The external RSS feed obtaining part 304 has the function of obtaining RSS feeds containing apparatus management information from other multi-function machines (not graphically illustrated) on the network 106 through the network service 223.

The external RSS feed management part 305 has the function of retaining the RSS feeds obtained by the external RSS obtaining part 304 and providing the RSS feed provision part 302 with the RSS feeds.

Further, the external OPML obtaining part 306 has the function of obtaining, from each of other multi-function machines (not graphically illustrated) on the network 106 through the network service 223, an OPML file where all of the RSS feeds provided by the corresponding multi-function machine are put together in a list. The external OPML obtaining part 306 also has the function of providing the external RSS feed obtaining part 304 with the information on the RSS feeds written (contained) in the OPML file.

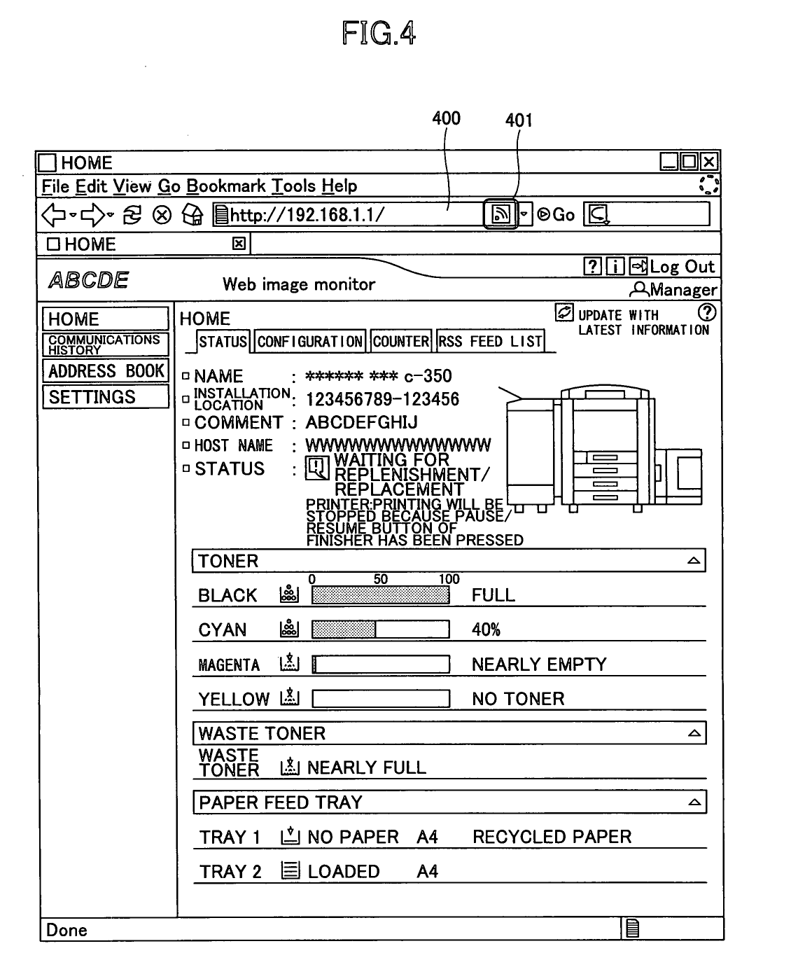

FIG. 4 is an image diagram showing a Web page that the Web screen provision part 301 provides to a Web browser operated by a user. It is assumed that the multi-function machine 10 provides three types of RSS feeds—apparatus status (including energy saving status and error occurrence status), residual toner amount (including waste toner bottle status), and paper feed tray status—as apparatus management information.

Of several types of Web pages provided by the multi-function machine 10, FIG. 4 shows one called “top page.” Usually, the Web page of FIG. 4 can be displayed by entering the IP address of the multi-function machine 10 in an address bar 400 of the Web browser.

Referring to FIG. 4, apparatus management information items such as apparatus name, installation location, comment, host name, status, residual toner amount, waste toner bottle status, and paper feed tray status are displayed on the Web page. That is, the Web page of FIG. 4 provides the user with these apparatus management information items.

RSS writes a summary of the information provided by a Web site or Web page in a structured manner. For example, the RSS feeds corresponding to the Web page of FIG. 4, that is, the contents of a summary of information to be provided, are apparatus status, residual toner amount, and paper feed tray status.

Accordingly, in the case of having the Web page of FIG. 4 displayed by the Web browser, it is desirable to notify the user that the RSS feeds of apparatus status, residual toner amount, and paper feed tray status correspond to the Web page of FIG. 4.

Common Web browsers have the function of notifying a user of the presence of an RSS feed upon displaying a Web page if information on the RSS feed has been written in a predetermined format in the Web page. This mechanism is referred to as “RSS auto-discovery.”

In the case of FIG. 4, since the Web page containing RSS feed information is displayed, an icon 401 indicating the presence of an RSS feed is displayed in the address bar 400 of the Web browser. When the icon 401 is clicked, the RSS feed information is displayed on the Web browser. Accordingly, it is possible to have a user perform operations such as entering the RSS feed information in the RSS reader.

Therefore, on the Web page of FIG. 4, the user is notified of the presence of the three RSS feeds of apparatus status, residual toner amount, and paper feed tray status using such a function for notifying a user of the presence of an RSS feed.

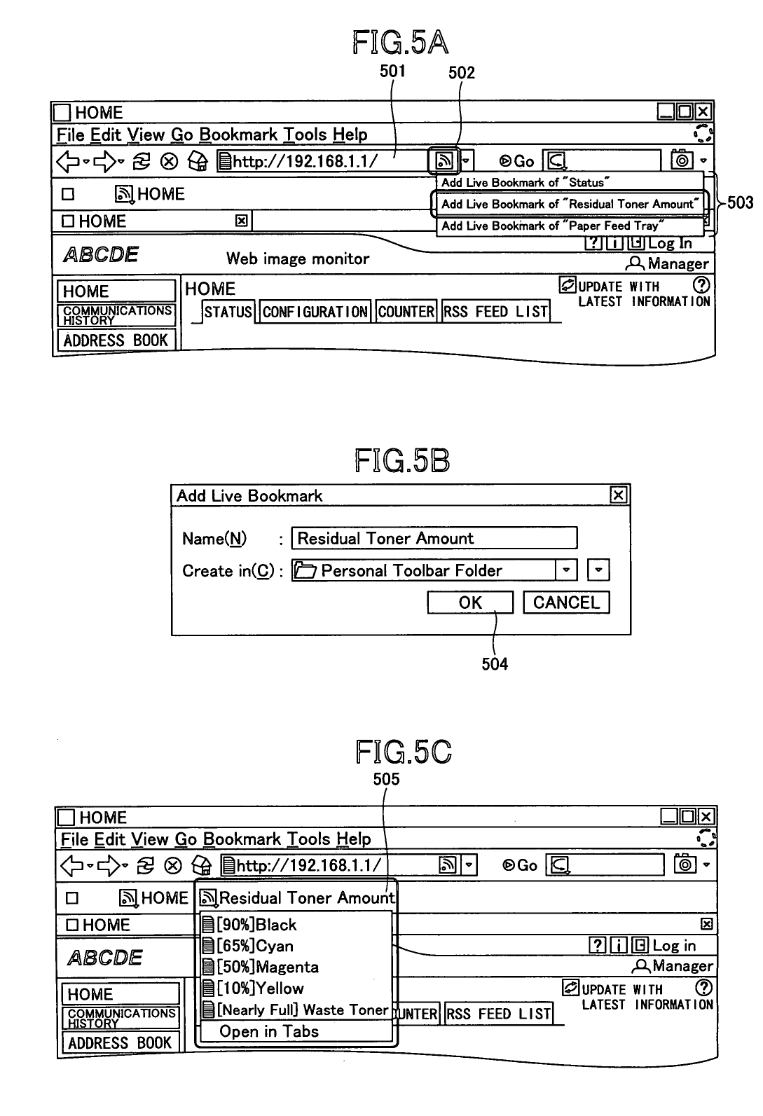

FIGS. 5A through 5C are diagrams showing a transition of screens illustrating an operation in the case of entering RSS feeds in the RSS reader using RSS auto-discovery. When a user clicks an RSS icon 502 displayed in an address bar 501, three types of RSS feeds 503 of apparatus status, residual toner amount, and paper feed tray status are displayed on the Web page as shown in FIG. 5A.

When the user clicks “RESIDUAL TONER AMOUNT” among the RSS feeds 503, a confirmation screen of addition of a live bookmark as shown in FIG. 5B is displayed. The user may change the name of the live bookmark or the destination in which the live bookmark is to be created using the confirmation screen of addition as required.

When the user clicks an OK button 504 on the confirmation screen of addition of the live bookmark as shown in FIG. 5B, the RSS feed of residual toner amount is entered and displayed in the toolbar. FIG. 5C shows the Web page where the user has clicked the RSS feed entered and displayed in the toolbar. When the user clicks the RSS feed of residual toner amount entered and displayed in the toolbar, information 505 (the residual amount of each toner and the status of a waste toner bottle) provided by the RSS feed of residual toner amount is displayed on the Web page.

In the case of FIG. 5C, the user can view or check the information 505 (the residual amount of each toner and the status of a waste toner bottle) provided by the RSS feed of residual toner amount on the Web page.

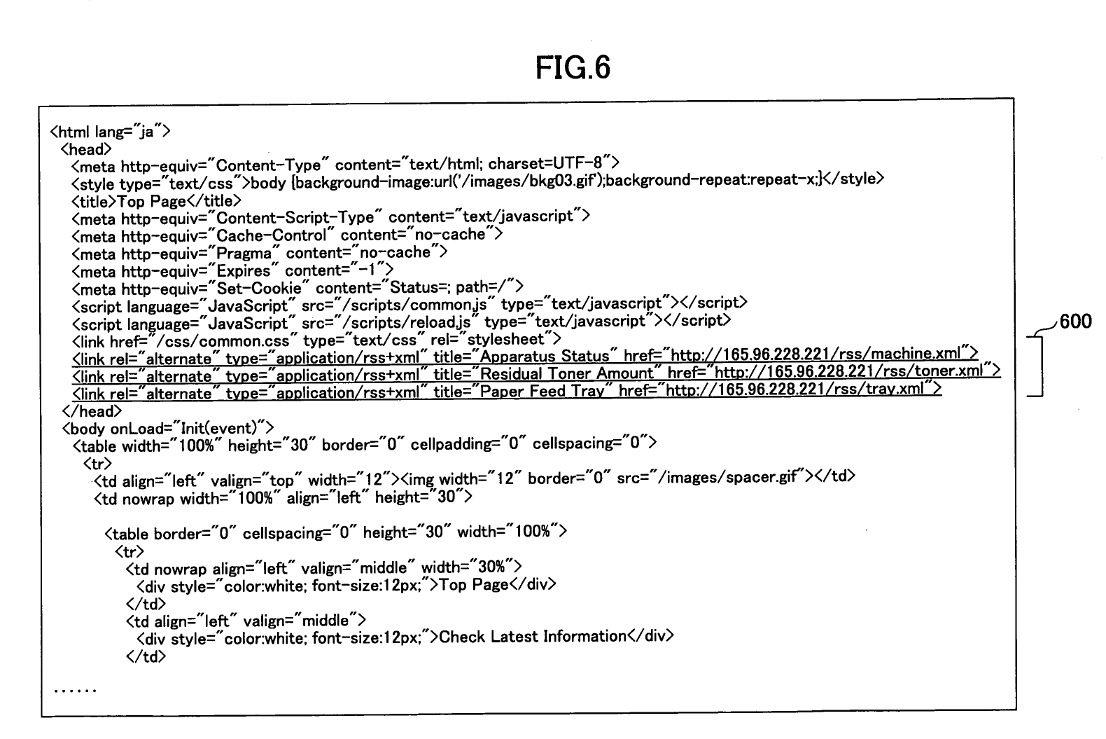

FIG. 6 is a diagram illustrating an example of HTML source code in the case of making a description for implementing RSS auto-discovery in a Web page provided by the Web screen provision part 301. FIG. 6 shows the HTML source code of the top page described with reference to FIG. 4.

As described above, the three types of RSS feeds—apparatus status, residual toner amount, and paper feed tray status—are provided on the top page. Of the HTML source code of FIG. 6, an underlined part 600 serves as a description for RSS auto-recovery of the three types of RSS feeds.

The Web page can support RSS auto-discovery by specifying “alternate” and “application/rss+xml” as the rel attribute and the type attribute, respectively, of a link element and specifying the title and URL of an RSS feed as the title attribute and the href attribute, respectively, of the link element.

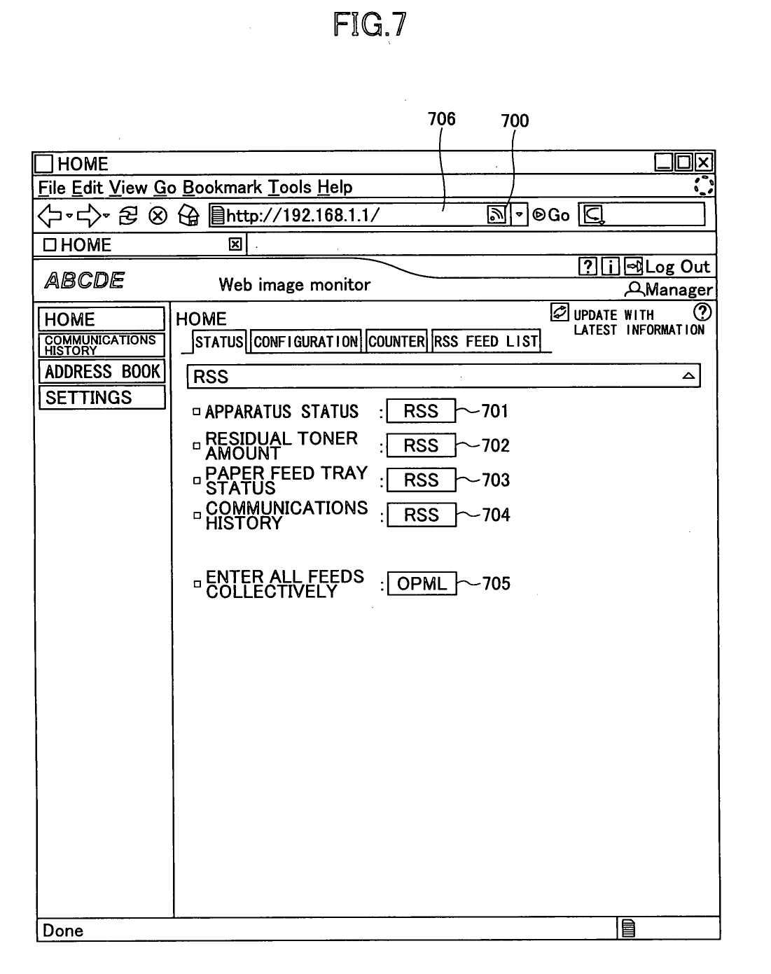

FIG. 7 is an image diagram showing a Web page that displays a list of RSS feeds provided by the multi-function machine 10 and serves to cause an OPML file into which the RSS feeds are put together to be downloaded.

The Web page of FIG. 7 shows a list of all the RSS feeds provided by the RSS feed provision part 302 (FIG. 3). The Web page of FIG. 7 is provided for also notifying a user who is unaware of an icon 700 indicating RSS auto-discovery or a user who uses a Web browser that does not support RSS auto-discovery of the RSS feeds provided by the multi-function machine 10.

Icons 701 through 704 show and serve as links to the corresponding RSS feeds. Each of the icons 701 through 704 is clicked to display XML data (RSS source), which are the contents of the corresponding RSS feed, on the Web browser. A user can enter the RSS feed by copying a URL displayed in an address bar 706 and pasting it into the RSS reader. Accordingly, a user can select necessary RSS feeds and enter them in the RSS reader one by one.

Further, an icon 705 that indicates a link to the URL of an OPML file (OPML feed) for collectively entering the RSS feeds in the RSS reader is displayed on the Web page of FIG. 7. The icon 705 is clicked to display XML data (OPML source), which are the contents of the OPML file, on the Web browser. A user can enter all the RSS feeds written (contained) in the OPML file in the RSS reader at a time by copying a URL displayed in the address bar 706 and pasting it into the RSS reader or by temporarily storing the URL in a file and causing the RSS reader to read the URL.

A user is also notified of the presence of each RSS feed through RSS auto-discovery on the Web page of FIG. 7. Unlike in the case of the top page, a user is notified of the presence of each of the RSS feeds of apparatus status, residual toner amount, paper feed tray status, and communications history on the Web page of FIG. 7.

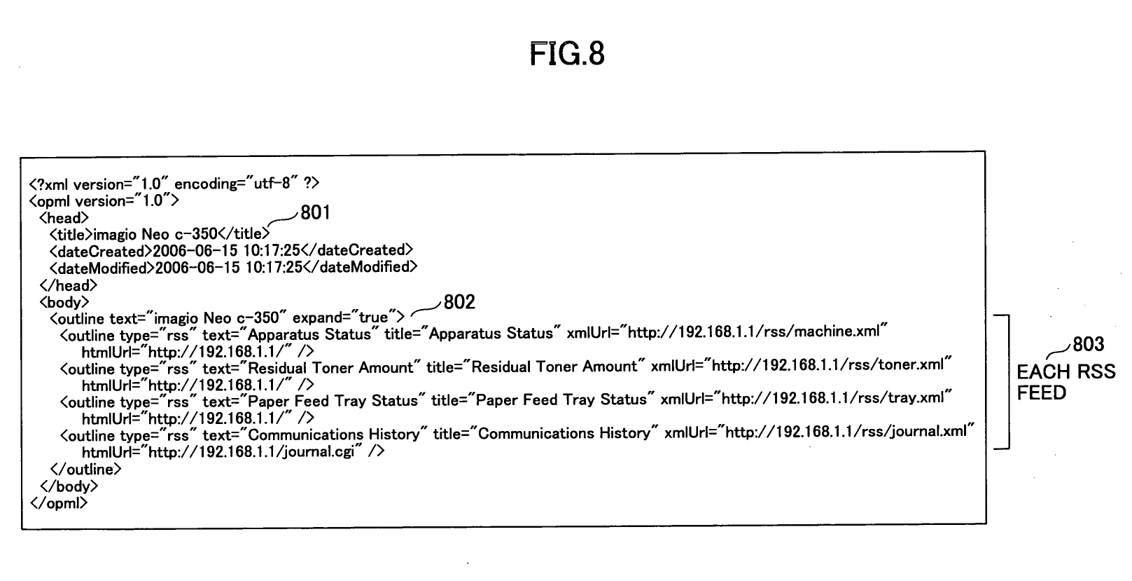

FIG. 8 is a diagram showing an OPML file provided by the OPML file provision part 303. The RSS feed provision part 302 provides four types of RSS feeds—apparatus status, residual toner amount, paper feed tray status, and communications history—as apparatus management information. Therefore, information on these four RSS feeds is written or embedded in the OPML file.

Information items written in the OPML file include a name 801 of the multi-function machine 10 that provides the OPML file, the name 802 of the multi-function machine 10 that is a provider of the RSS feeds, and information 803 on each RSS feed. The names 801 and 802 are the same in the OPML file of FIG. 8, but may be different.

The RSS feed information 803 includes the names, URLs, and distributor URLs of the RSS feeds. Here, as the distributor URL of each RSS feed, the URL of a Web page where the details of information provided by the RSS feed can be viewed is written. That is, the URL of the top page is written as the distributor URL of each of the RSS feeds of apparatus status, residual toner amount, and paper feed tray status, and the URL of a Web page of communications history is written as the distributor URL of the RSS feed of communications history.

### First Embodiment

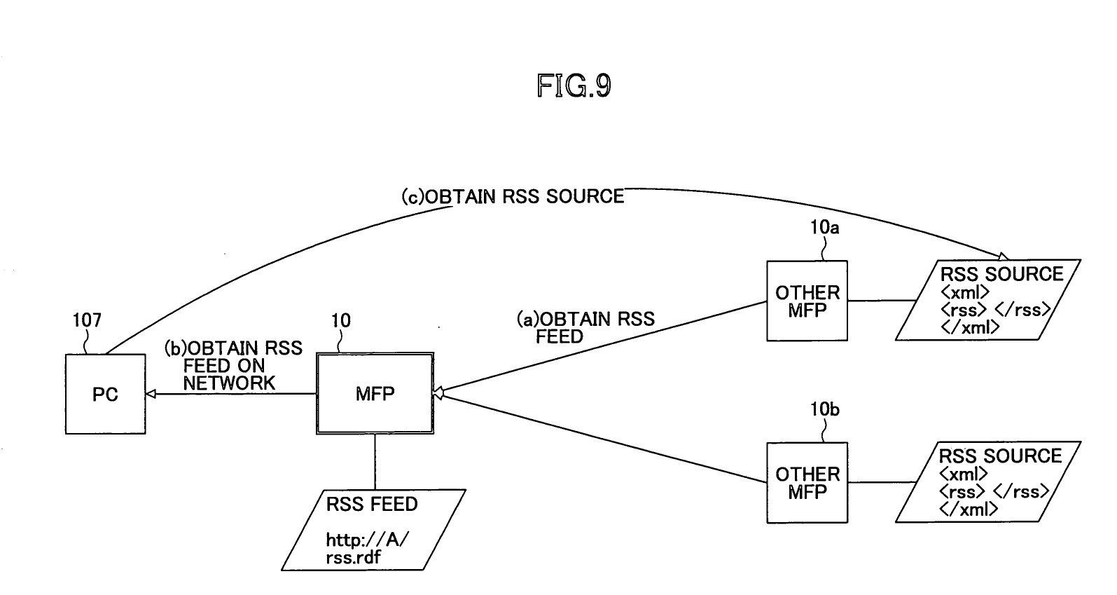

FIG. 9 is a system configuration diagram schematically showing an operation of the multi-function machine 10 according to a first embodiment of the present invention.

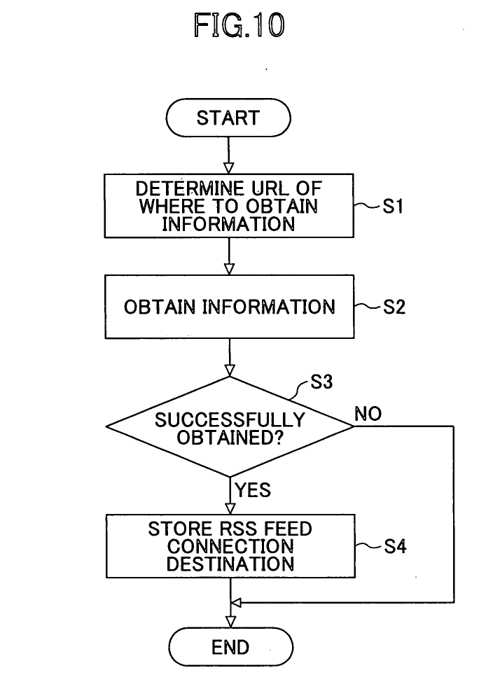

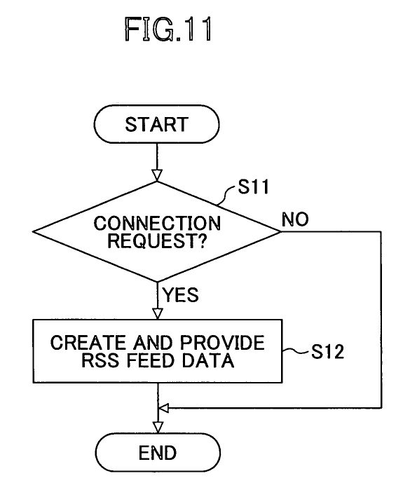

FIGS. 10 and 11 are flowcharts showing the operation of the multi-function machine 10 according to the first embodiment of the present invention.

In response to an OPML file obtaining request made by an operation, in step S1 of FIG. 10, the multi-function machine 10 determines a connection destination based on pre-registered information (such as IP addresses or URLs).

In step S2, the multi-function machine 10 obtains information from the determined connection destination (in this case, each of other [or external] multi-function machines 10a and 10b). Usually, the access is made according to HTTP. In the case of a URL providing a service, there is a response in OPML data. If the multi-function machine 10 succeeds in obtaining a response in OPML data (YES in step S3), the multi-function machine 10 retains the OPML data in the external OPML file obtaining part 306 and then proceeds to step S4.

In step S4, the multi-function machine 10 determines a URL that is providing an RSS feed, or determines the RSS feed, based on the OPML data. The multi-function machine 10 retains the determined RSS feed in the external RSS feed management part 305.

Referring to FIG. 11, in step S11, the multi-function machine 10 determines whether there is a connection request from the PC 107 operated by a user. If there is a connection request from the PC107 operated by a user (YES in step S11), in step S12, the multi-function machine 10 provides the PC 107 with the RSS feeds of the other network apparatuses 10a and 10b the same as the RSS feeds of the multi-function machine 10. The RSS feeds are provided to the PC 107 using, for example, the above-described Web page of FIG. 4 or FIG. 7.

The RSS feeds may not be provided in OPML data, but may be written as RSS auto-discovery in a Web page. In this case, the external OPML file obtaining part 306 has the function of analyzing the HTML data of the Web page and retaining the RSS feed information.

The PC 107 that has obtained the RSS feeds can obtain RSS sources from the RSS feeds of the multi-function machines 10, 10a, and 10b. The above-described OPML file obtaining request may be made not only by an operation but also by periodic polling or in response to reception of a request to obtain an RSS feed. Further, the pre-registered information may be multiple information items.

### Second Embodiment

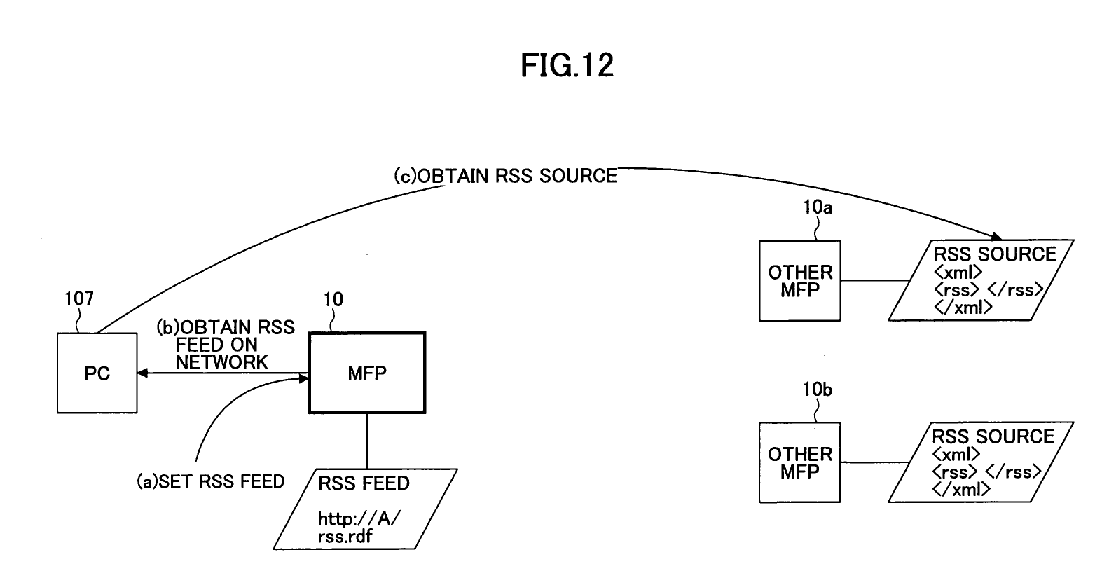

FIG. 12 is a system configuration diagram schematically showing an operation of the multi-function machine 10 according to a second embodiment of the present invention.

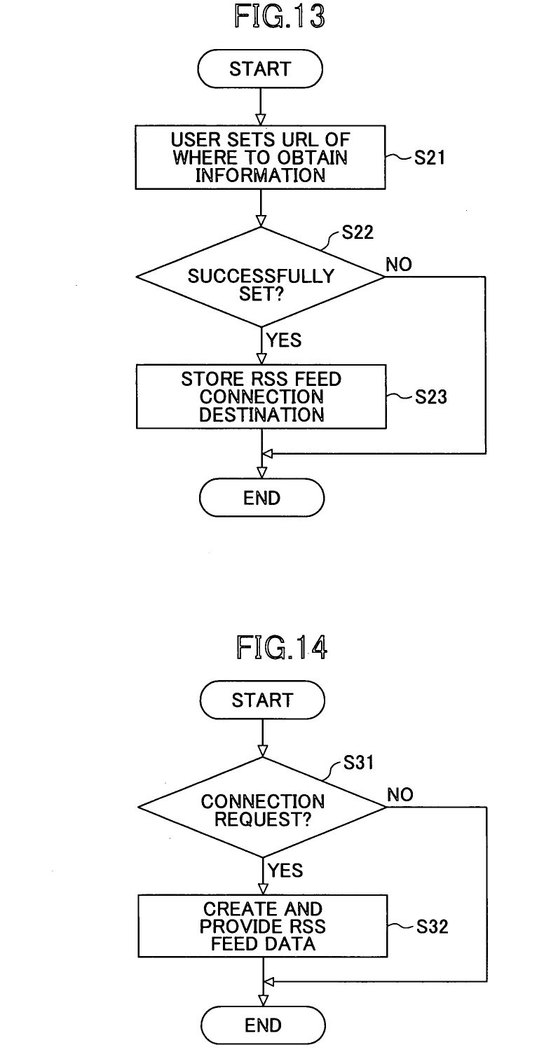

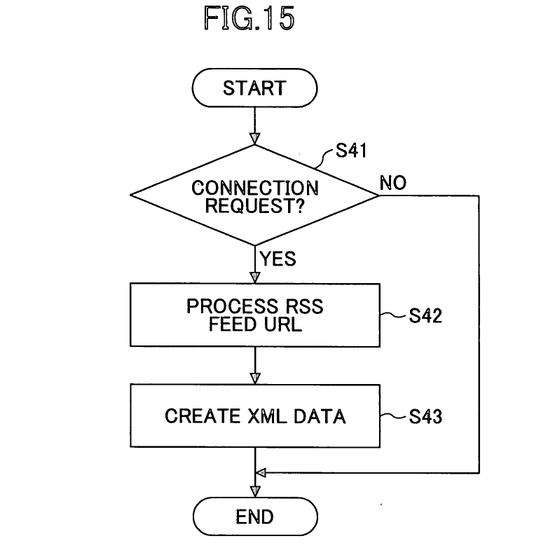

FIGS. 13 and 14 are flowcharts showing the operation of the multi-function machine 10 according to the second embodiment of the present invention.

In response to an RSS feed setting request from the operations panel, in step S21 of FIG. 13, the multi-function machine 10 sets RSS feeds based on the RSS feed setting request. When the RSS feeds have been successfully set (YES in step S22), in step S23, the multi-function machine 10 retains the set RSS feeds in the external RSS feed management part 305.

Referring to FIG. 14, in step S31, the multi-function machine 10 determines whether there is a connection request from the PC 107 operated by a user. If there is a connection request from the PC107 operated by a user (YES in step S31), in step S32, the multi-function machine 10 provides the PC 107 with the RSS feeds of the other network apparatuses 10a and 10b the same as the RSS feeds of the multi-function machine 10. The RSS feeds are provided to the PC 107 using, for example, the above-described Web page of FIG. 4 or FIG. 7.

The multi-function machine 10 can set RSS feeds not only through the operations panel but also using a Web browser, for example. The PC 107 that has obtained the RSS feeds can obtain RSS sources from the RSS feeds of the multi-function machines 10, 10a, and 10b.

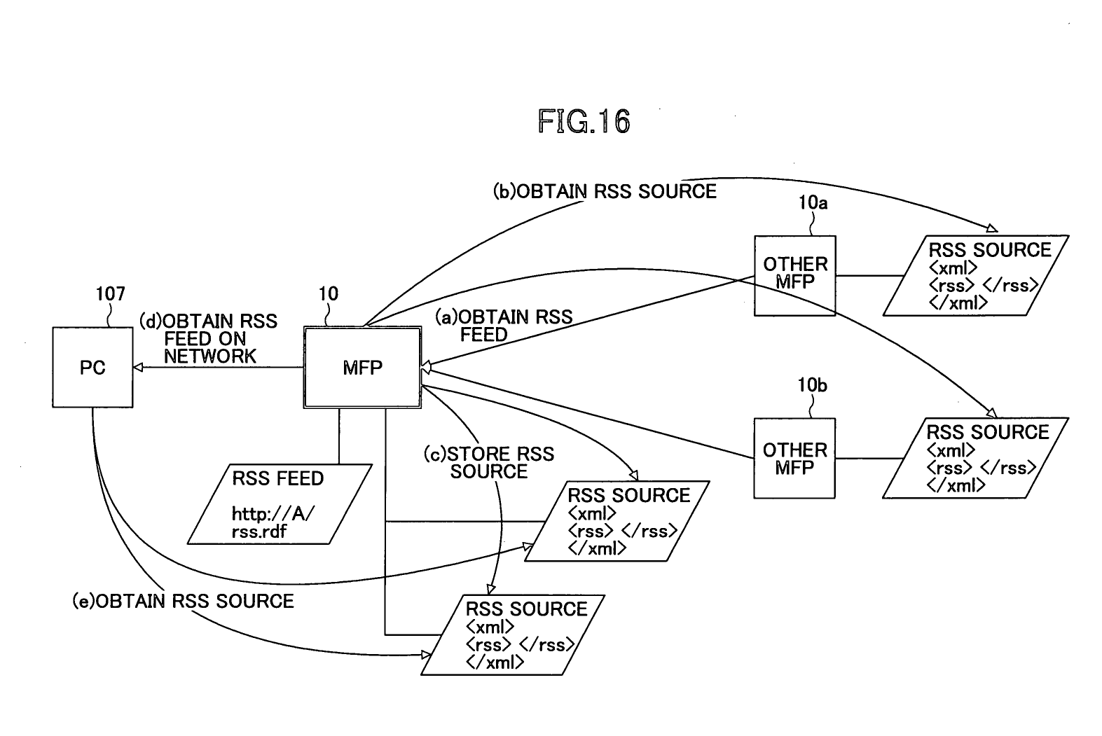

In response to a request from the PC 107 for obtained RSS feeds, the multi-function machine 10 may transmit the RSS feeds after performing processing shown in FIG. 15 on the RSS feeds. FIG. 15 is a flowchart showing processing on obtained RSS feeds.

Referring to FIG. 15, in step S41, the multi-function machine 10 determines whether there is a connection request from the PC 107 operated by a user. If there is a connection request from the PC107 operated by a user (YES in step S41), in step S42, the multi-function machine 10 performs predetermined processing on RSS feeds. Examples of the processing on RSS feeds include deletion of a redundant RSS feed (item), rearrangement of items according to update time, rearrangement of items according to access frequency, and reduction of the number of items to a specified number.

The processing on RSS feeds may be specified from the PC 107 (user) side. For example, the PC 107 may specify the processing on RSS feeds as a parameter of httpGET as http://xxx.xxx.xxx.xxx/comLogTx/rss.rdf?data=new.

Then, the multi-function machine 10 proceeds to step S43, and can provide the PC 107 with the processed RSS feeds. The RSS feeds are provided to the PC 107 using, for example, the above-described Web page of FIG. 4 or FIG. 7. The processing shown in FIG. 15 may also be performed on the RSS feeds of the first embodiment.

### Third Embodiment

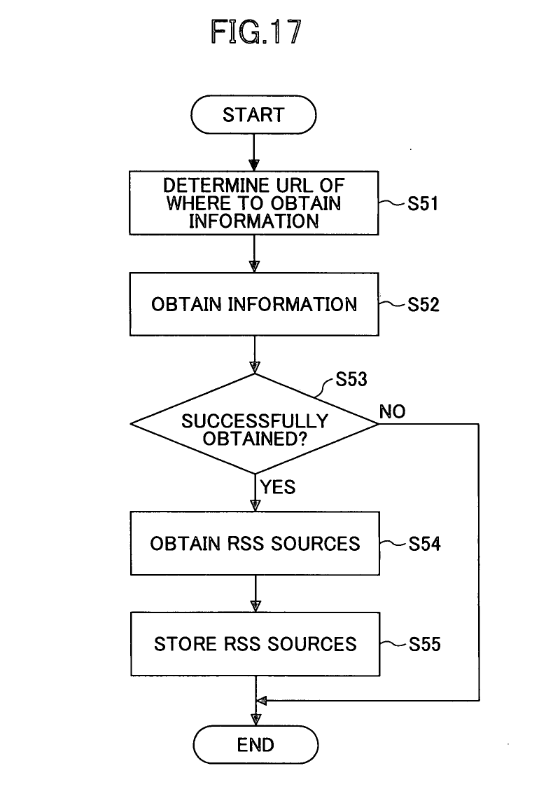

FIG. 16 is a system configuration diagram schematically showing an operation of the multi-function machine 10 according to a third embodiment of the present invention.

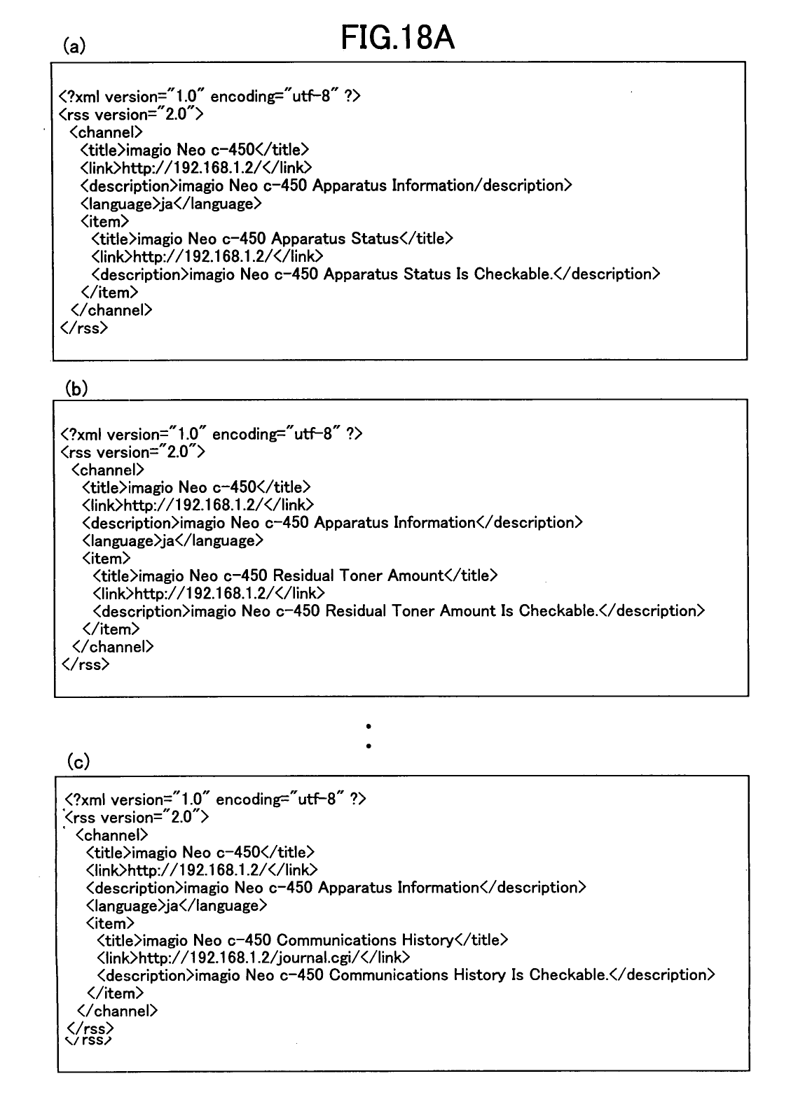

FIG. 17 is a flowchart showing the operation of the multi-function machine 10 according to the third embodiment of the present invention.

FIG. 16 schematically shows an operation in the case of obtaining the RSS sources provided by the other multi-function machines 10a and 10b and providing the URLs of the obtained RSS sources, that is, the RSS feeds, to, for example, the PC 107 (user). FIG. 17 shows the operation in a flowchart.

First, in step S51 of FIG. 17, the multi-function machine 10 determines the URLs of where to obtain information, that is, the other multi-function machines 10a and 10b on the network 106. The determination may be made in the same manner as described above with reference to FIGS. 9 and 10.

Next, in step S52, the multi-function machine 10 accesses the URLs of the multi-function machines 10a and 10b, and obtains the RSS feeds provided by the multi-function machines 10a and 10b. Then, if the multi-function machine 10 succeeds in obtaining the RSS feeds in step S53, the multi-function machine 10 proceeds to step S54.

In step S54, the multi-function machine 10 accesses the URLs shown by the RSS feeds to obtain RSS sources. Then, in step S55, the multi-function machine 10 directly stores the RSS sources obtained in step S54 without processing them.

In response to the PC 107 (user)'s access to the multi-function machine 10, the multi-function machine 10 provides the PC 107 with the URLs of the RSS sources, that is, the RSS feeds, of the multi-function machine 10 and the RSS feeds for the RSS sources obtained from the other multi-function machines and stored.

The PC 107 accesses the provided RSS feeds and obtains the RSS sources, thereby accessing the information of the multi-function machines 10, 10a, and 10b. In this case, the obtained RSS sources are not those provided by the other multi-function machine 10a or 10b but those contained in the multi-function machine 10.

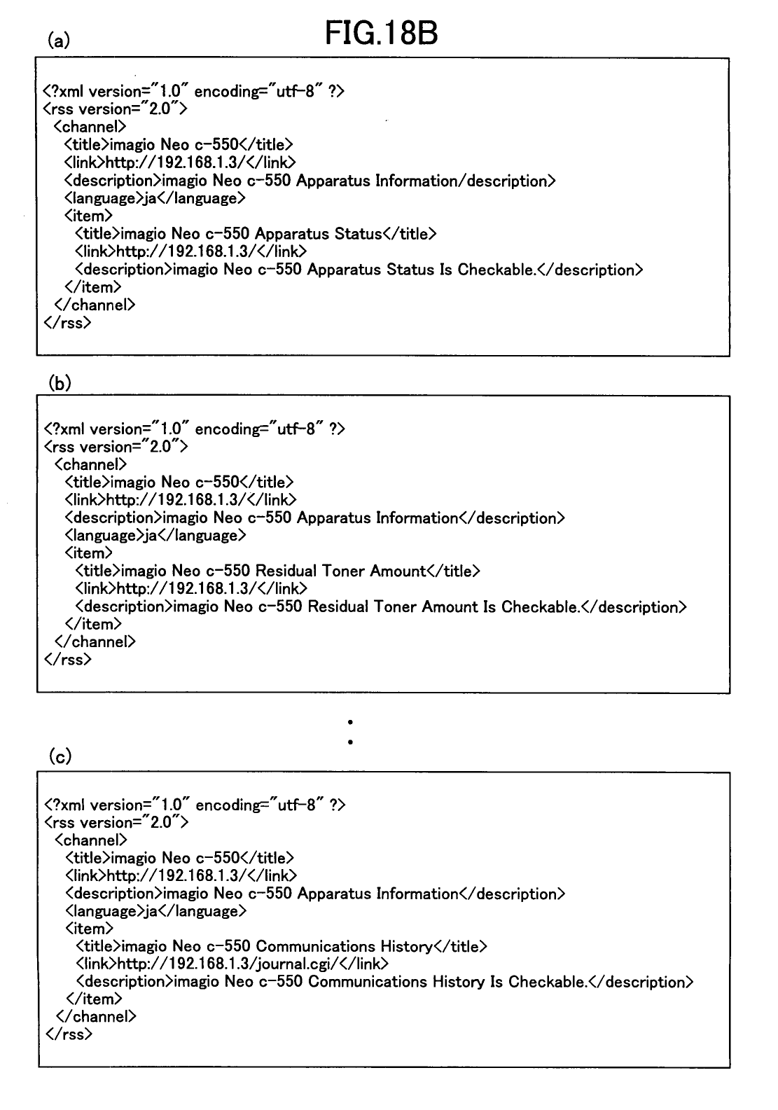

FIG. 18A shows example RSS sources obtained from the other multi-function machine 10a and stored in the multi-function machine 10. FIG. 18B shows example RSS sources obtained from the other multi-function machine 10b and stored in the multi-function machine 10.

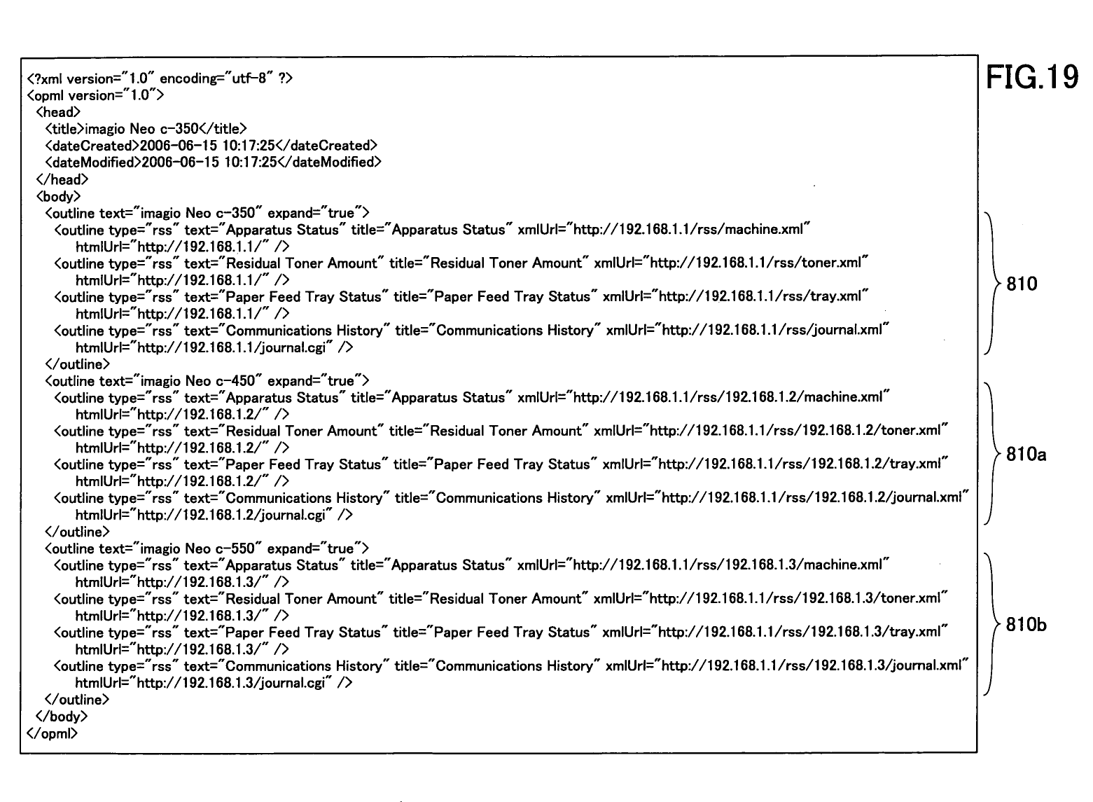

FIG. 19 shows an OPML source containing RSS feeds 810 provided by the multi-function machine 10 and RSS feeds 810a and 810b that are the URLs of the RSS sources obtained from the other multi-function machines 10a and 10b, respectively. The RSS sources 810a and 810b obtained from the other multi-function machines 10a and 10b are directly stored without processing, and are provided on an apparatus basis without processing in the case of being provided in the OPML source.

### Fourth Embodiment

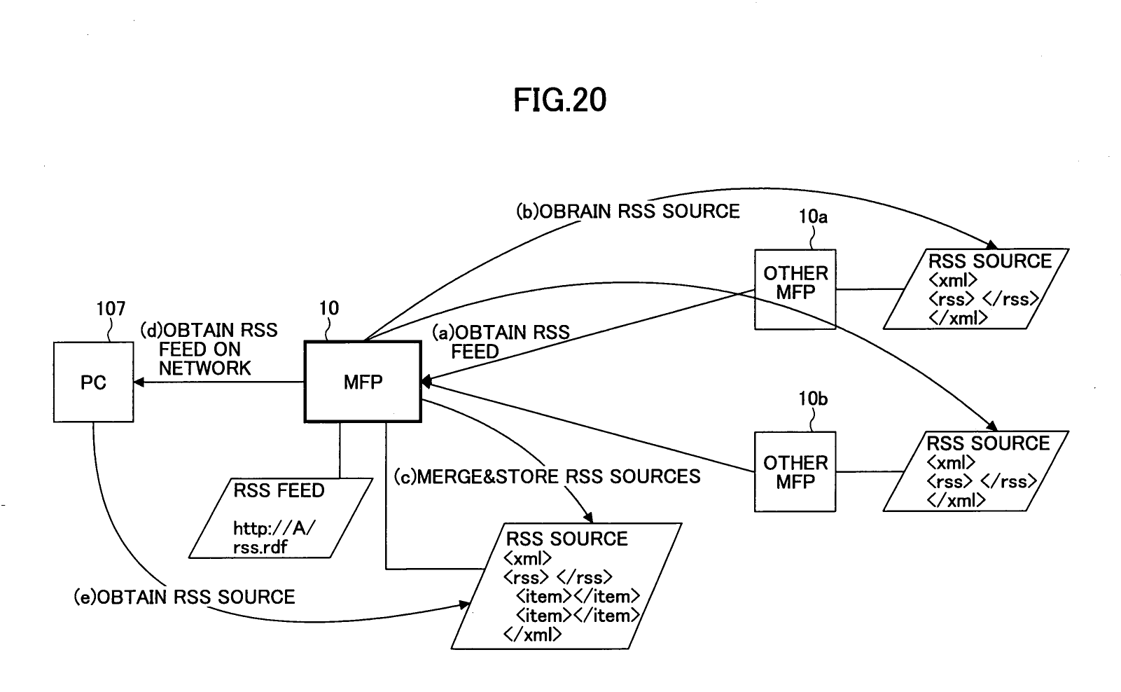

FIG. 20 is a system configuration diagram schematically showing an operation of the multi-function machine 10 according to a fourth embodiment of the present invention.

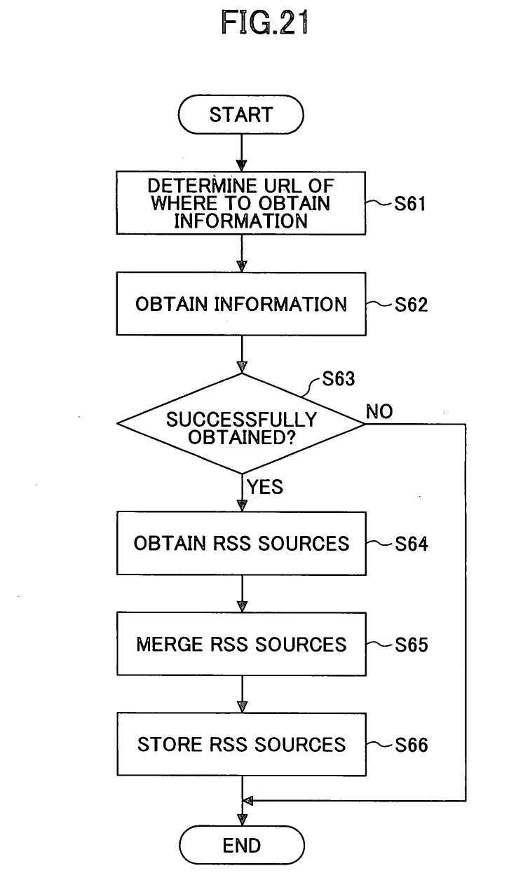

FIG. 21 is a flowchart showing the operation of the multi-function machine 10 according to the fourth embodiment of the present invention.

FIG. 20 schematically shows an operation in the case of obtaining the RSS sources provided by the other multi-function machines 10a and 10b and providing the URLs of the obtained RSS sources, that is, the RSS feeds, to, for example, the PC 107 (user) FIG. 21 shows the operation in a flowchart.

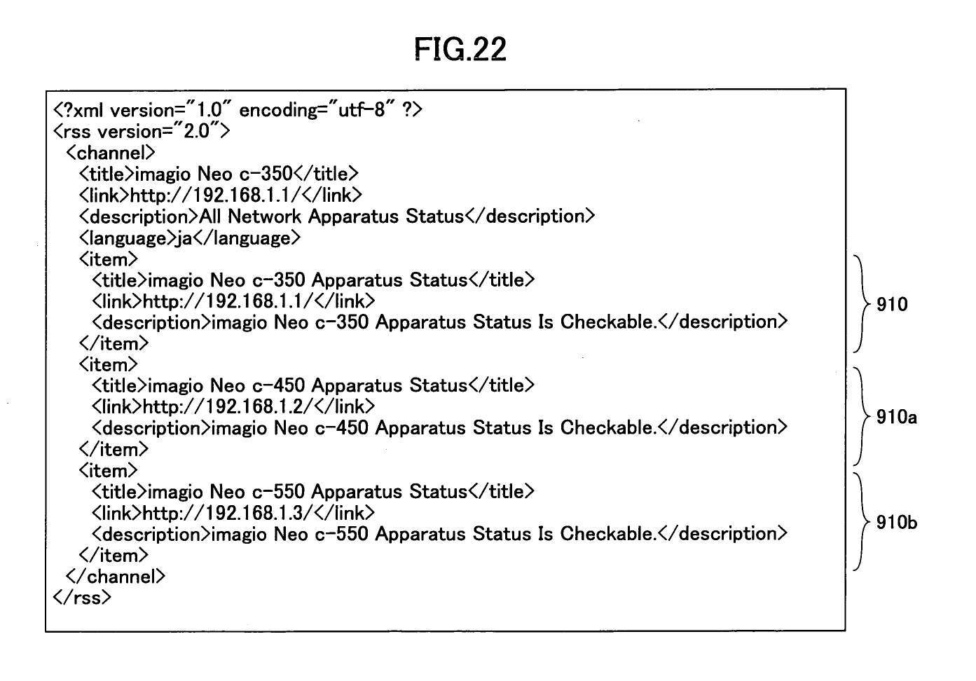

The difference between FIG. 16 and FIG. 20 lies in that while the obtained RSS sources are directly stored in FIG. 16, information on the obtained RSS sources and information on the RSS sources provided by the multi-function machine 10 are merged, but otherwise FIGS. 16 and 17 are the same. That is, the flowchart of FIG. 21 is different from the flowchart of FIG. 17 in additionally including the processing of step S65. FIG. 22 shows an RSS source into which RSS sources 910a and 910b obtained from the other multi-function machines 10a and 10b, respectively, and RSS sources 910 provided by the multi-function machine 10 are merged.

[Method of Searching for Other Multi-function Machines on Network]

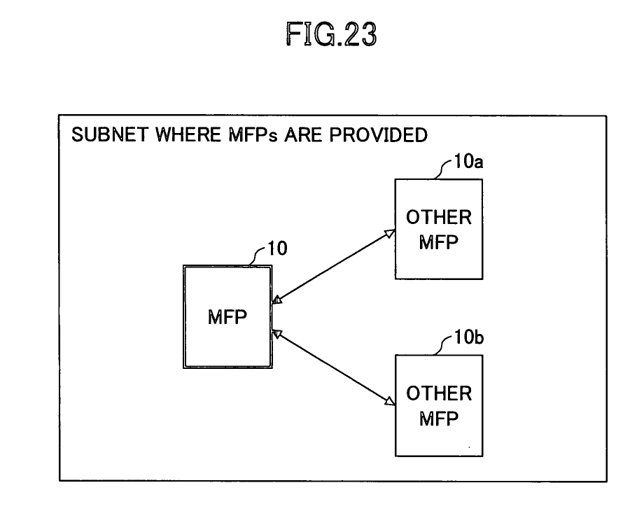

FIG. 23 is a schematic diagram showing a subnet where multi-function machines are provided according to an embodiment of the present invention.

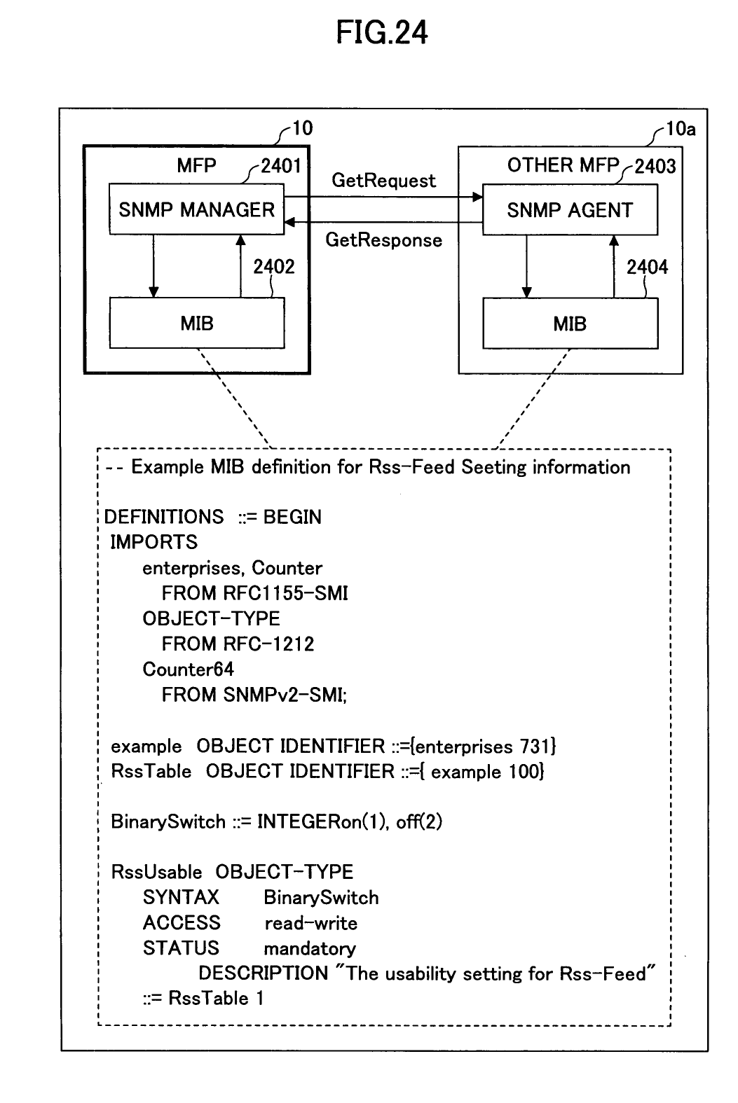

FIG. 24 is a system configuration diagram schematically showing an operation of searching for other multi-function machines on the network.

As shown in FIG. 23, the multi-function machine 10 and the other multi-function machines 10a and 10b are provided on the same subnet.

Further, the multi-function machine 10 shown in FIG. 24 includes an SNMP manager 2401 and an MIB (Management Information Base) 2402. The other multi-function machine 10a includes an SNMP agent 2403 and an MIB 2404.

The SNMP manager 2401 obtains information by way of SNMP. The SNMP manager 2401 receives a response (GetResponse) from the other multi-function machine 10a having the SNMP agent 2403, and obtains information as to whether the RSS feed is available from the response, referring to information definitions in the MIB 2402.

The SNMP agent 2403 provides information by way of SNMP. The SNMP agent 2403 receives a request (GetRequest) from the SNMP manager 2401, and provides the SNMP manager 2401 with information as to whether the RSS feed is available, referring to information definitions in the MIB 2404.

The MIBs 2402 and 2404 define and manage information exchangeable between the SNMP manager 2401 and the SNMP agent 2403.

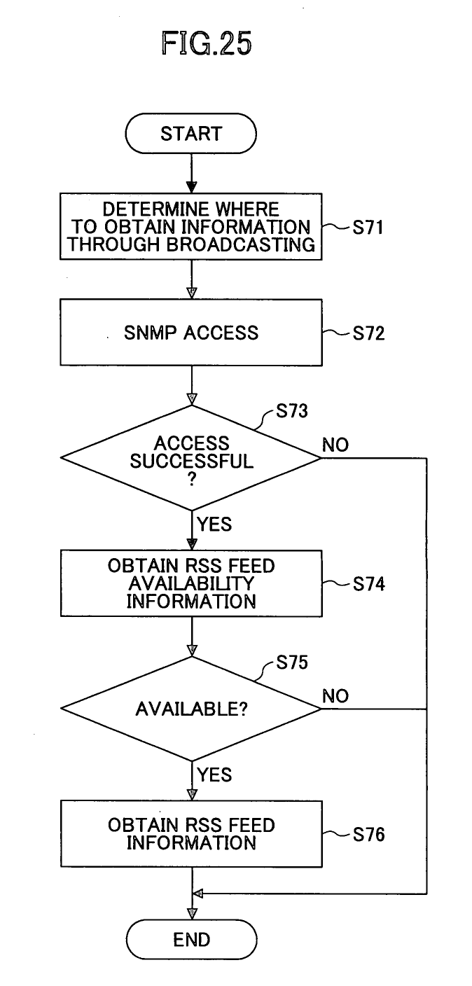

FIG. 25 is a flowchart showing an example of the operation of searching for other multi-function machines.

Referring to FIG. 25, in step S71, the multi-function machine 10 determines, through broadcasting, where to obtain RSS feed information on the subnet on which the multi-function machine 10 is provided. When the multi-function machine 10 determines where to obtain RSS feed information (such as the multi-function machine 10a), in step S72, the SNMP manager 2401 of the multi-function machine 10 accesses the other multi-function machine 10a provided on the same subnet according to SNMP, and obtains MIB information. On condition that the accessed multi-function machine 10a has the SNMP agent 2403 and the MIB 2404 defining information on the RSS feed availability, the access succeeds.

If the access succeeds (YES in step S73), in step S74, the SNMP manager 2401 of the multi-function machine 10 obtains the information on the RSS feed availability from the accessed multi-function machine 10a.

If the information on the RSS feed availability obtained from the multi-function machine 10a indicates that the RSS feed is available (YES in step S75), in step S76, the SNMP manager 2401 of the multi-function machine 10 obtains the RSS feed information from the multi-function machine 10a in the above-described information obtaining/processing manner. If the access according to SNMP fails (NO in step S73) or the obtained RSS feed availability information indicates that the RSS feed is not available (NO in step S75), the operation shown in the flowchart of FIG. 25 ends.

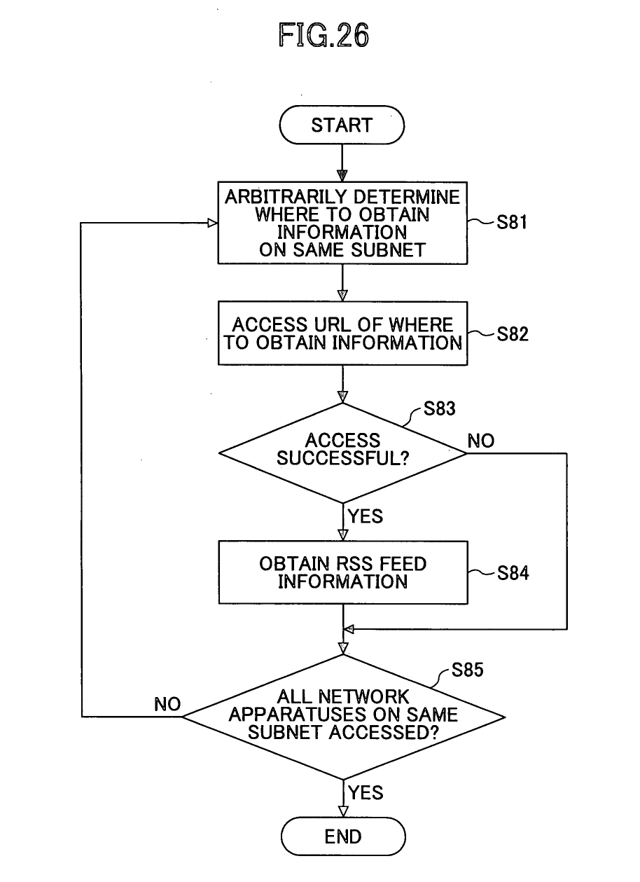

FIG. 26 is a flowchart showing an example of the operation of searching for other multi-function machines.

Referring to FIG. 26, in step S81, the multi-function machine 10 determines one of all the other multi-function machines including the multi-function machines 10a and 10b provided on the same subnet as a multi-function machine from which to obtain RSS feed information. In step S82, the multi-function machine 10 accesses a URL such as http://xxx.xxx.xxx.xxx/client1/comLogTx/rss.rdf according to HTTP with respect to the determined multi-function machine (for example, the multi-function machine 10a) from which to obtain RSS feed information. In this URL, “xxx.xxx.xxx.xxx” is the IP address of the access destination. Further, “client1/comLogTx/rss.rdf” is information (RSS feed) pre-registered by an operation.

On condition that there is an HTTP page containing the RSS feed information at the URL of the accessed multi-function machine 10a, the access succeeds. If the access succeeds (YES in step S83), in step S84, the SNMP manager 2401 of the multi-function machine 10 obtains the RSS feed information from the multi-function machine 10a in the above-described information obtaining/processing manner, and then proceeds to step S85. If the access fails in step S83, the SNMP manager 2401 also proceeds to step S85.

In step S85, the multi-function machine 10 ends the operation shown in the flowchart of FIG. 26 if all the other multi-function machines provided on the same subnet have been accessed. On the other hand, if all the other multi-function machines provided on the same subnet have not been accessed (NO in step S85), the multi-function machine 10 returns to step S81. That is, the multi-function machine 10 accesses a URL as described above according to HTTP with respect to each of all the other multi-function machines provided on the same subnet. Further, the multi-function machine 10 may use the OPML feed as the above-described pre-registered information.

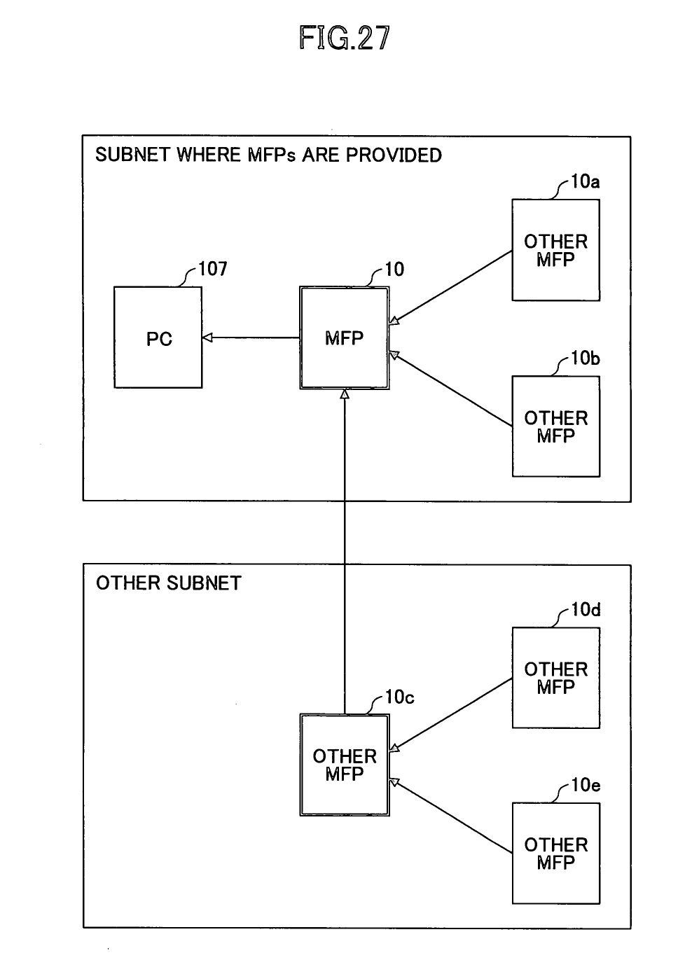

FIG. 27 is a system configuration diagram schematically showing an operation of searching for other multi-function machines on the network according to an embodiment of the present invention.

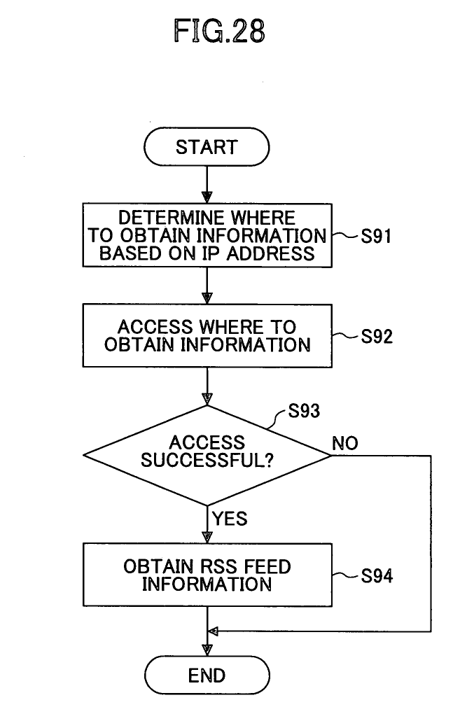

FIG. 28 is a flowchart showing an example of the operation of searching for other multi-function machines.

Referring to FIG. 27, the PC107, the multi-function machine 10, and the other multi-function machines 10a and 10b are provided on the same subnet. Further, other multi-function machines 10c through 10e are provided on another subnet.

Referring to FIG. 28, in step S91, the multi-function machine 10 determines the other multi-function machine 10c as a connection destination based on information (IP address) pre-registered through an operation. In step S92, the multi-function machine 10 makes an information obtaining request to the determined multi-function machine 10c. Usually, the access is made according to HTTP.

In response to the information obtaining request, the multi-function machine 10c, which is a connection destination, obtains information from the other multi-function machines 10d and 10e on the same subnet using the above-described search method shown in FIG. 25 or FIG. 26. Further, the multi-function machine 10c obtains RSS feed information from the multi-function machines 10d and 10e in the above-described information obtaining/processing manner, and provides the requestor multi-function machine 10 with the obtained RSS feed information.

If the registered IP address is that of a multi-function machine on a different subnet, multiple subnets can be searched beyond the limitations of the search methods shown in FIGS. 25 and 26. If the registered IP address is that of a multi-function machine in the same subnet, redundant information should be processed by the above-described information collection method. If the access succeeds (YES in step S93), in step S94, the multi-function machine 10 obtains information on the RSS feed availability information from the accessed multi-function machine 10c. If the access fails (NO in step S93), the operation shown in the flowchart of FIG. 28 ends.

Thus, according to one aspect of the present invention, in the case of managing the multiple multi-function machines 10, 10a, and 10b with an RSS reader, it is possible to enter or register all the RSS feeds provided by all the multi-function machines 10, 10a, and 10b to be managed in the RSS reader with ease if the IP address of at least one of the multi-function machines 10, 10a, and 10b (for example, the multi-function machine 10) is known. (The single multi-function machines 10 may provide multiple RSS feeds.)

Accordingly, a user can enter or register the RSS feeds of multiple apparatus management information items provided by the multiple multi-function machines 10, 10a, and 10b in the RSS reader with ease. Further, it is also possible to manage the multiple multi-function machines 10, 10a, and 10b only with the RSS reader without using special client software.

The Web server function of the multi-function machine 10 has the function of prompting a user viewing the information of the multi-function machine 10 using a Web browser to enter RSS feeds of apparatus management information in the RSS reader.

Further, the multi-function machine 10 provides the function of providing its multiple RSS feeds in a list of OPML format, thereby facilitating their collective (or batch, as a unit) entry into the RSS reader.

Further, the multi-function machine 10 has the function of capturing information on RSS feeds provided by other multi-function machines on the network (for example, the multi-function machine 10a), which provide apparatus management information through the RSS feeds, and providing the captured information (URLs or contents of the RSS feeds) together with the RSS feeds provided by the multi-function machine 10 itself.

Thus, it is possible to make it easy for a user to find RSS feeds provided by one or more multi-function machines and to enter the RSS feeds in the RSS reader.

According to one embodiment of the present invention, there is provided a network apparatus providing data-related information outside the network apparatus in accordance with a format of structured description, the data-related information being related to data to be provided, the network apparatus including an external data storage location management part configured to manage the data storage location of data-related information of an external network apparatus; and a data storage location provision part configured to provide, outside the network apparatus, the data storage location of the data-related information of the network apparatus and the data storage location of the data-related information of the external network apparatus.

According to one embodiment of the present invention, there is provided a data provision location providing method of a network apparatus providing data-related information outside the network apparatus in accordance with a format of structured description, the data-related information being related to data to be provided, the data provision location providing method including the steps of reading the data storage location of data-related information of an external network apparatus from the external data storage location management part of the network apparatus managing the data storage location; and providing, outside the network apparatus, the data storage location of the data-related information of the network apparatus and the data storage location of the data-related information of the external network apparatus.

According to one embodiment of the present invention, there is provided a computer-readable recording medium on which is recorded a program for causing a computer having a processor, a storage unit, and a communications unit to execute processing according to a data provision location providing method of a network apparatus providing data-related information outside the network apparatus in accordance with a format of structured description, the data-related information being related to data to be provided, the program causing the computer to execute the steps of causing the processor to read the data storage location of the data-related information of an external network apparatus from the external data storage location management part of the network apparatus managing the data storage location; and providing, outside the network apparatus, a data storage location of the data-related information of the network apparatus and the data storage location of the data-related information of the external network apparatus, using the communications unit.

According to embodiments of the present invention, it is possible to provide a network apparatus capable of accurately and easily providing the data storage location of information related to data provided by the network apparatus and other network apparatuses, a data provision location providing method of the network apparatus, and a recording medium storing a program for causing a computer to execute the data provision location providing method of the network apparatus.

Further, methods, apparatuses, systems, computer programs, recording media, and data structures to which elements, expressions, or any combination of elements of the present invention is applied are also effective as modes of the present invention.

The present invention is not limited to the specifically disclosed embodiments, and variations and modifications may be made without departing from the scope of the present invention.

The present application is based on Japanese Priority Patent Application No. 2006-281739, filed on Oct. 16, 2006, the entire contents of which are hereby incorporated by reference.

What is claimed is:

1. A network apparatus providing data-related information outside the network apparatus in accordance with a format of structured description, the data-related information being related to data to be provided, the network apparatus comprising:
an external data storage location management part configured to manage a data storage location of data-related information of an external network apparatus; and
a data storage location provision part configured to provide, outside the network apparatus, a data storage location of the data-related information of the network apparatus and the data storage location of the data-related information of the external network apparatus.

2. The network apparatus as claimed in claim 1, further comprising:
an information provision part configured to provide the data-related information of the network apparatus to a requester of the data-related information in response to a request from the requester specifying the data storage location of the data-related information of the network apparatus.

3. The network apparatus as claimed in claim 1, further comprising:
a Web server part configured to provide a Web page outside the network apparatus,
wherein the data storage location provision part is configured to embed the data storage location of the data-related information of each of the network apparatus and the external network apparatus in the Web page using the Web server part.

4. The network apparatus as claimed in claim 1, further comprising:
a file provision part configured to write a list of the data storage locations of the data-related information of the network apparatus and the external network apparatus in a file and to provide the file outside the network apparatus.

5. The network apparatus as claimed in claim 4, further comprising:
a Web server part configured to provide a Web page outside the network apparatus,
wherein the file provision part is configured to embed the file in the Web page using the Web server part and to provide the file outside the network apparatus.

6. The network apparatus as claimed in claim 1, further comprising:
an external data storage location obtaining part configured to obtain the data storage location of the data-related information of the external network apparatus from the external network apparatus.

7. The network apparatus as claimed in claim 6, wherein the external data storage location obtaining part is configured to cause a user to register a location where the data storage location of the data-related information of the external network apparatus is obtained.

8. The network apparatus as claimed in claim 6, wherein the external data storage location management part is configured to remove the data storage location of the data-related information in response to the data storage location being redundant.

9. The network apparatus as claimed in claim 1, further comprising:
an information obtaining part configured to obtain the data-related information of the external network apparatus from the external network apparatus; and
an information storage part configured to store the obtained data-related information,
wherein the data storage location provision part is configured to provide, outside the network apparatus, a data storage location of the data-related information stored in the information storage part as the data storage location of the data-related information of the external network apparatus.

10. The network apparatus as claimed in claim 9, wherein:
the information storage part is configured to store the data-related information as obtained as a unit, and
the data storage location provision part is configured to provide, outside the network apparatus, the data storage location of the data-related information as the data storage location of the data-related information of the external network apparatus in the unit of the data-related information stored in the information storage part.

11. The network apparatus as claimed in claim 9, wherein:
the information storage part is configured to merge the obtained data-related information and the data-related information of the network apparatus and to store the merged data-related information as a single item at a time of storing the obtained data-related information, and
the data storage location provision part is configured to provide, outside the network apparatus, the data storage locations of the data-related information in a unit of the data-related information stored in the information storage part.

12. A data provision location providing method of a network apparatus providing data-related information outside the network apparatus in accordance with a format of structured description, the data-related information being related to data to be provided, the data provision location providing method comprising the steps of:
reading a data storage location of data-related information of an external network apparatus from an external data storage location management part of the network apparatus managing said data storage location; and
providing, outside the network apparatus, a data storage location of the data-related information of the network apparatus and the data storage location of the data-related information of the external network apparatus.

13. The data provision location providing method as claimed in claim 12, further comprising the step of:
providing the data-related information of the network apparatus to a requester of the data-related information in response to a request from the requestor specifying the data storage location of the data-related information of the network apparatus.

14. A computer-readable recording medium on which is recorded a program for causing a computer having a processor, a storage unit, and a communications unit to execute processing according to a data provision location providing method of a network apparatus providing data-related information outside the network apparatus in accordance with a format of structured description, the data-related information being related to data to be provided, the program causing the computer to execute the steps of:
causing the processor to read a data storage location of data-related information of an external network apparatus from an external data storage location management part of the network apparatus managing said data storage location; and
providing, outside the network apparatus, a data storage location of the data-related information of the network apparatus and the data storage location of the data-related information of the external network apparatus, using the communications unit.

15. The computer-readable recording medium as claimed in claim 14, wherein the program further causes the computer to execute the step of:
providing the data-related information of the network apparatus to a requester of the data-related information in response to a request from the requester specifying the data storage location of the data-related information of the network apparatus.
